(19) United States
(12) Patent Application Publication
(10) Pub. No.: US 2018/0180970 A1
(43) Pub. Date: Jun. 28, 2018

(54) Morphable Identity, Networkable Photonic Quantum Logic Gate System & Method

(71) Applicant: Daniel S. Klotzer, Saint Louis, MO (US)

(72) Inventor: Daniel S. Klotzer, Saint Louis, MO (US)

(21) Appl. No.: 15/900,118

(22) Filed: Feb. 20, 2018

Related U.S. Application Data
(63) Continuation-in-part of application No. 13/735,823, filed on Jan. 7, 2013, now Pat. No. 9,897,894.
Application No. 13/735,823 is a continuation-in-part of application No. 12/655,792, filed on Jan. 6, 2010, now Pat. No. 8,350,211.
Application No. 12/655,792 is a continuation-in-part of application No. 10/757,615, filed on Jan. 13, 2004, now Pat. No. 7,777,177.
(60) Provisional application No. 60/439,712, filed on Jan. 13, 2003.

(51) Int. Cl. G02F 3/00; G06N 99/00

(52) U.S. Cl. CPC G02F 3/00; G06N 99/002

(57) ABSTRACT

Optical information processing systems and methods including quantum computing logic gates, quantum computing memory configurations, and quantum computing entanglement discernment methods. Realization manners include linear optical components as well as rectangular waveguides lithographed on silicon chips.

### CROSS-REFERENCE TO RELATED APPLICATIONS

This application is a continuation-in-part of U S. Non-Provisional Utility patent application Ser. No. 13/735,823, filed on Jan. 7, 2013, to be issued as U.S. Pat. No. 9,897,894 on Feb. 20, 2018, and claims the benefit of its filing date; and is as well a continuation in part of U.S. Non-Provisional Utility patent application Ser. No. 12/655,792 filed Jan. 6, 2010, issued as U.S. Pat. No. 8,350,211 on Jan. 8, 2013, and claims the benefit of its priority date. The Ser. No. 12/655,792 application is a continuation-in-part of U.S., Non-Provisional Utility patent application Ser. No. 10/757,615, filed Jan. 13, 2004, and claims the benefit of its priority date as does the present application; the Ser. No. 10/757,615 application priority date stems from U.S. Provisional Utility Patent Application Ser. No. 60/439,712, filed Jan. 13, 2003, which is also the priority date claimed by the present application; and the entire disclosures of all of the U.S. Non-Provisional Utility patent application Ser. No. 13/735,823; Ser. No. 12/655,792; U.S. Non-Provisional Utility patent application Ser. No. 10/757,615, and U S. Provisional Utility Patent Application Ser. No. 60/439,712, are all hereby incorporated herein by reference.

### STATEMENT REGARDING FEDERALLY SPONSORED RESEARCH OR DEVELOPMENT

Not applicable.

### BACKGROUND OF THE INVENTION

### Field of the Invention

The present invention relates generally to systems and methods of implementing logic gates with photons, and more particularly to expanding the capabilities made available by the implementing of such gates with quantum computing and quantum memory capacities as well as superposition of states discrimination.

### Related Art

The incorporation herein by reference of the complete disclosure of the parent application of the present application: U.S. patent application Ser. No. 13/735,823, filed Jan. 7, 2013, to be issued as U.S. Pat. No. 9,897,894 on Feb. 20, 2018; is in order to provide the complete description of the logic gates of FIGS. 1 & 2 which are also integral and/or optional and/or suitable aspects of other embodiments of the present invention. The logic gates of FIGS. 1 & 2, in differing combinations with varying other aspects of the embodiments of the present invention, provide a suite of morphable photonic information processing capabilities within a single configuration due to the logic gates', and other aspects' morphabilities.

A quantum computing system involves additional forms of components in addition to processing logic gates, and embodiments of the present invention include the combinations of these quantum computing logic gates with others of these components, such as quantum computing switches, quantum computing memories, and quantum computing state discerners.

A substantial number of techniques and achievements in the field of photonic manipulation, computation, and quantum computation have been effected, and are being researched. A number of these efforts are hereby incorporated by reference, as described in the United States published patent database. It should be understood that these references are incorporated solely for their efficacy in describing the various technical capacities that exist, for purposes of enablement of the embodiments of the present invention disclosed herein only. In no way are these considered to be prior art, nor are they anticipatory nor do they render obvious any of the present application. Additionally, in some of the incorporated references, there may be assertions of judgment and/or characterization that can be construed to be subjective in some way and these are not a part of the present application. These references' incorporation is solely intended to provide further details of a variety of manners of effecting some of the techniques utilized in the present invention, since the enablement is judged at the time of filing and does not adjust for the present application's claim of earlier priority. With these limitations understood, the references incorporated herein by reference are U.S. Pat. Nos. 6,298,180; 6,473,541; 6,633,053; 6,678,450; 6,788,838; 6,819,474; 7,180,645; 7,498,832; 7,714,605; 7,791,780; 7,836,007; 7,844,152; 7,925,131; and 8,031,985; as well as United States Published Patent Application Nos. 20080310000; 20100098373, and 20120039560 as contributing context to explicate the technical capacities available to achieve the operations of the embodiments of the present invention, the inventive aspects of which have not been previously disclosed.

Primarily for enablement reasons, and in order to establish the present state of the art represented as the knowledge possessed by a PHOSITA (Person of Hypothetical Ordinary Skill In The Art,) a number of patent publications are incorporated herein by reference to delineate some of the range of currently well-known techniques which are available to realize various aspects of various embodiments of the present invention. These references include both patent and non-patent literature, and they describe techniques which range from the theoretical through to those in testing and on to those already being industrially utilized. It should be understood however, that the incorporation and or listing of any reference or technique is explicitly not an admission or description that that reference or technique is prior art, but rather is only a description of varying manners of realizing various embodiments of the present invention. The embodiments of the present invention are already reduced to practice, and due to the early priority of the parent applications to the present application the vast majority, if not all, of these reductions to practice actually predate the material that will be incorporated by reference subsequently. And while priority is determined by the earliest explication of the parent application(s), enablement is defined in terms of the state of knowledge on the filing date of the present application, and hence references that are not prior art to the present application are still incorporated by reference for that reason. The embodiments of the present invention explicated in detail here include certain forms of optical equipment, such as beam splitters and half-wave plates, though the range of well-known equipment types that are incorporable with the embodiments of the present invention are not limited in principal or practice, and the inclusion of any of these equipment types should be understood to fall within the scope of the present invention.

### SUMMARY OF THE INVENTION

In order to configure an information processing system that also has the quantum computing capabilities of the quantum computing logic gates described by the present application's parent application (U.S. patent application Ser. No. 13/735,823), additional capabilities are desirable including the processing systems described in the embodiments of the present application that variously incorporate a memory function, a switching function, and a state form discerning function. In varying combinations, these components provide (but do not limit to) the quantum computing processing systems of the present application's embodiments the abilities to interrelate, process, store, route, recall, discern, and/or coordinate information and the processing thereof, including various permutations of the morphing and networking capacities of the parent application's quantum computing logic gates.

A number of varying embodiments fall within the scope of the present invention. A first embodiment is characterizable as a photon processing aspect of a quantum-computing photon processing system, comprising a receiver/communicator of photons sent to a first superpositioner that arranges a first superposition of distinguishable photon first and second states, wherein said distinguishableness enables differentiable influences upon the first and second states; one or more conditioners to differentiably influence the first and second states to engender conditioned states that exhibit influenced degrees of constructive or destructive self-interference; an interference actuator that institutes self-interference of the conditioned states; and one or more photon post-self-interference state outputs. A second embodiment is characterizable as an additional photon processing aspect of a quantum-computing photon processing system of the first embodiment, wherein said influencing comprises utilizing Kerr media to engender degrees of phase alteration of one or more of the first and second states. A third embodiment is characterizable as an additional photon processing aspect of a quantum-computing photon processing system of the first embodiment % wherein said conditioner utilizes one or more resonators, including micro-ring resonator variants, and said influencing comprises utilizing Kerr media to engender degrees of phase alteration of one or more of the first and second states.

A fourth embodiment is characterizable as a quantum computing method's photon processing technique, comprising the steps of receiving and communicating one or more photons to a first superpositioner for arranging a symmetrical superposition of first and second photon states; selectively differentiably influencing the first and second states to engender conditioned states with selectively influenced phase relationships, including selectively switching the first and second states between in-phase and π-out-of-phase relationships; instituting self-interference of the conditioned states with an interference actuator; and outputting one or more photon post-self-interference states. A fifth embodiment is characterizable as an additional quantum-computing method's photon processing technique of the fourth embodiment, with said outputting including photon third and fourth states, further comprising the steps of selectively differentiably influencing the polarization of the third and/or fourth states and then recombining the paths of the polarization differentiated third and fourth states.

A sixth embodiment is characterizable as a photon processing aspect of a quantum-computing photon processing system, comprising: a first receiver that communicates first photons to a first superpositioner that arranges a first superposition of first and second first photon distinguishable states, said distinguishableness enabling differentiable influences upon the first photon distinguishable states; a second receiver that communicates second photons to a second superpositioner that arranges a second superposition of second photon first and second distinguishable states, said distinguishableness enabling differentiable influences upon the second photon distinguishable states; one or more photon conditioners that differentiably influence distinguishable photon states, the degree of influencing corresponding with the degree of occupancy of the distinguishable states being concurrently conditioned, with each of the first photon distinguishable states being concurrently influenced by one or more of the second photon distinguishable states, wherein conditioning engendered first photon conditioned states, when re-interfered, exhibit altered degree of constructive or destructive self-interference; an interference actuator that self-interferes the first photon conditioned states; and first and second, first photon post-self-interference state outputs.

A seventh embodiment is characterizable as an additional photon processing aspect of a quantum-computing photon processing system of the fifth embodiment, wherein said first photon conditioner's influencing involves degrees of alteration of the phase of the distinguishable photon states, including a potential zero degree of alteration, and said phase alterations involve micro-ring resonators and Kerr media. An eighth embodiment is characterizable as an additional photon processing aspect of a quantum-computing photon processing system of the sixth embodiment, further comprising a first photon first conditioner interrelating the first and second photons' first distinguishable states and a first photon second conditioner interrelating the first and second photons' second distinguishable states; wherein the first superpositioner arranges equal probability amplitudes of first photon occupancy of the first and second distinguishable states, and the second superpositioner arranges horizontally polarized second photon states into occupancy of the second photon first distinguishable state and vertically polarized second photon states into occupancy of the second photon second distinguishable state; wherein the first photon conditioner's influencing involves degrees of alteration of the phase of the distinguishable photon states, including a potential zero degree of alteration, said phase alterations involving micro-ring resonators and Kerr media, and/or functional equivalents; such that when the second photons are initially in only vertical or horizontal polarization states, the first photon post-self-interference first output state is occupied, and when the second photons are initially in a superposition of horizontal and vertical polarization states, the first photon post-self-interference second output state is occupied.

A ninth embodiment is characterizable as a quantum non-demolition entangled-photon-state discernment method embodiment, comprising the steps of: arranging a first photon into a symmetrical first superposition of first photon first and second states; arranging a second photon into a second superposition of horizontal polarization states forming a second photon first state and vertical polarization states forming a second photon second state; employing distinct micro-ring resonators and Kerr media induced phase alterations to interrelate, separately, the first and second photons' first superpositioned states in a first pair, and their second superpositioned states in a distinct second pair, configuring said interrelating so that the second photon first and second superpositioned states separately induce unshared phase alterations of the first photon first and second states, respectively, wherein the degree of each first photon phase alteration corresponds to the respective probability amplitude of the second photon's horizontal and vertical polarization states; and interfering the first photon phase altered first and second states, including an option of interfering with an anti-symmetrical beam splitter, with a first output path for first photon added probability amplitudes and a second output path for subtracted first photon probability amplitudes.

A tenth embodiment is characterizable as an additional quantum non-demolition entangled-photon-state discernment method of the ninth embodiment operating on a first series of equivalent first photons and second series of equivalent second photons with each of the second photons in an individual second series having either, equal horizontally and vertically polarized state probability amplitudes, or zero probability amplitude of one of the horizontally and vertically states; further comprising the steps of: executing the method of the ninth embodiment on the first and second series and determining, for each series, the relative number of first photons traversing the first and second output paths, identifying those first photon series in which the second output path is rarely or completely untaken and then identifying the corresponding second photon series; and estimating, with confidence strength corresponding to the photon series' sizes, that the second photons in the identified corresponding second series that are traversing a post-recombined-state output path have equivalent probability amplitude vertical and horizontal states.

An eleventh embodiment is characterizable as a photon processing, quantum non-demolishing, superposition-of-state gauging method, comprising the steps of: organizing each of first and second photons into separate superpositions of first and second states, wherein the first photon's superposition's first and second states are symmetrical, and the second photon's superposition's first and second states are polarized, with the second photon first state being horizontally polarized and the second photon second state being vertically polarized; interrelating each photon's first and second superpositioned state with the other photon's first and second superpositioned state, respectively; traversing each of separate first and second phase modifiers with one each of the pairs of interrelated states, said phase modifiers using micro-ring resonators and Kerr media; arranging said modifiers to engender alike phase modifications on traversing states when the traversing states are occupied alike, and interfering first photon, now phase modified, first and second states at an anti-symmetrical beam splitter, wherein the anti-symmetrical beam splitter's first output path is occupied by added input states and its second output path is occupied by subtracted input states.

A twelfth embodiment is characterizable as an additional photon processing, quantum non-demolishing, superposition-of-state gauging method of the eleventh embodiment, wherein a photon A initially shares an entangled state ψ_{A or B}=(1/\sqrt{2}) [H_{A}V_{B}+H_{B}V_{A}], or a functionally equivalent state, with a second photon B, and subsequently is still in the entangled state, or is in one of a pair of post-entangled states ψ_{A}=H_{A}V_{B} (or) V_{A}H_{B} when photon A is subsequently processed as the second photon in the method of the eleventh embodiment, further comprising the step of identifying which of the beam splitter first or second output paths the first photon traversed, and ascertaining that the second photon entered said processing in the entangled state when the first photon traverses the first output path, or ascertaining that the second photon entered said processing in one of the post-entangled states when the first photon traverses the second output path.

A thirteenth embodiment is characterizable as a photon processing, quantum non-demolishing, superposition-of-state gauging method, comprising the steps of: organizing a first photon into a symmetrical first superposition of first and second states; organizing a second photon into a second superposition of third and fourth states, said second photon organizing producing symmetrical third and fourth state probability amplitudes when the second photon was in a first pre-organizing state; interrelating separately the superpositioned first photon's first and second states with the superpositioned second photon's first and second states, respectively; arranging micro-ring resonators and Kerr media as separate phase modifiers of photon states traversing each of the interrelatings, wherein the amount of phase modification effected is responsive to the total probability amplitude of the photon states traversing a particular phase modifier, so that the first photon first and second states receive equivalent phase modifications when the second photon was in the first pre-organized state, and optionally recombining the second photon third and fourth states; interfering the first photon phase modified first and second states at an anti-symmetrical beam splitter having an first output path occupied by added input states and a second output path occupied by subtracted input states; and non-demolishingly determining that the second photon was initially in the first pre-organizing state when the output path of added input states is always occupied, or equivalently when the output path of subtracted input states is never occupied. A fourteenth embodiment is characterizable as an additional photon processing, quantum non-demolishing, superposition-of-state gauging method according to the method of claim 13, wherein when the output path of added input states is not always occupied, or equivalently when the output path of subtracted input states is sometimes occupied, further comprising one or more steps of altering said organizing of the second photon into an altered second superposition of states and re-performing the method of claim 13 until the second photon pre-organizing state is identified when the output path of added input states is always occupied, or equivalently when the output path of subtracted input states is never occupied.

A fifteenth embodiment is characterizable as a quantum non-demolishing photon state characterization method, comprising the steps of: a first arranging of a first photon into a symmetrical first superposition of first photon first and second states; a second arranging of a second photon into an asymmetrical second superposition of second photon third and fourth states; organizing distinct micro-ring resonators and Kerr media induced phase alterations to interrelate, separately, the first and third superpositioned states, and the second and fourth superpositioned states, wherein the degree of each separate phase alteration relates to the total probability amplitude of the photon states concurrently traversing that Kerr media; interfering the first photon phase altered first and second states at an asymmetrical beam splitter having a first added input state output path and a second subtracted input state output path; identifying when the added input states output path is occupied, or identifying when the subtracted inputs output state is not occupied, indicating at least a first characteristic of the pre-arranging state of the second photon; identifying when the subtracted input states output path is occupied, or alternatively identifying when the added inputs output state is not occupied, indicating at least a second characteristic of the pre-arranging state of the second photon. A sixteenth embodiment is characterizable as an additional quantum non-demolishing photon state characterization extension of the fifteenth embodiment, when all the second photons each initially share an entangled state ψ_{2,3}ⁱ=(1/\sqrt{2}) [H₂V₃+H₃V₂] with third photons and at a later time, though still prior to the fifteenth embodiment method, in a first variant the second photons are in the entangled state, and in a second variant the second photons are in a random assortment of post-entangled states ψ₂^{p}=H₂V₃ or ψ₂^{p}=V₂H₃ when the third photon's polarization state is resolved, and wherein the second superposition is arranged into horizontally polarized third states and vertically polarized fourth states, further comprising, after performing the method of the fifteenth embodiment on a population of the second photons that are all either of the first or second variant, the step of ascertaining whether the first or the second characteristic of the pre-arranged states of the second photons is identified, with the first characteristic corresponding to the first variant second photons entering the method of the fifteenth embodiment, and the second characteristic corresponding to the second variant second photons entering the method of the fifteenth embodiment.

A seventeenth embodiment is characterizable as a photon processing feature of a quantum-computing photon processing system, comprising: first and second photon processing aspects, the first aspect including, a first beam splitter that arranges a first superposition of distinguishable photon first and second states, wherein said distinguishableness enables differentiable influences upon the first and second states; one or more conditioners to differentiably influence the first and second states to engender first and second conditioned states; a first interference actuator that institutes interference of the first and second conditioned states at a second beam splitter, and post-first-interference photon first and second output states; a second beam splitter that arranges a second superposition of distinguishable photon third and fourth states, wherein said distinguishableness enables differentiable influences upon the third and fourth states; one or more conditioners to differentiably influence the third and fourth states to engender third and fourth conditioned states; a second interference actuator that institutes interference of the third and fourth conditioned states at a third beam splitter; and post-second-interference photon fifth and sixth output states; wherein the first and second output states are the distinguishable photon third and fourth states.

An eighteenth embodiment is characterizable as an additional photon processing feature of a quantum-computing photon processing system of the seventeenth embodiment, wherein the first and third beam splitters are the same beam splitter. A nineteenth embodiment is characterizable as an additional photon processing feature of a quantum-computing photon processing system of the seventeenth embodiment, wherein the first and third beam splitters are the same anti-symmetric beam splitter, and one or more photons is circulating about the photon processing feature from the first beam splitter through one or more of the first superpositioned states, then interfering at the second beam splitter and next traversing one or more of the second superpositioned states en route to crossing the first beam splitter, and potentially repeating; and the circulating photons are arranged in either a first disposition, wherein the first and second superpositioned states are in phase and have equal (√2)−1 probability amplitudes of occupancy, and the third superpositioned state is occupied by the added-input-paths output state of the first beam splitter with a probability amplitude of 1, or in a second disposition, wherein the first and second superpositioned states are π out of phase and have equal (√2)⁻¹ probability amplitudes of occupancy, and the fourth superpositioned state is occupied by the subtracted-input-paths output state of the first beam splitter with a probability amplitude of 1. A twentieth embodiment is characterizable as an additional photon processing feature of a quantum-computing photon processing system of the nineteenth embodiment, further comprising one or more phase modifiers for selectively effecting a phase modification on a modifier-traversing photon state, including a phase modification of magnitude π radians, wherein said traversing photon states include one or more of the first through fourth superpositioned states. A twenty-first embodiment is characterizable as an additional photon processing feature of a quantum-computing photon processing system of the twentieth embodiment, in combination with one or more photonic quantum computing logic gates configured to utilize said feature as a binary photon state memory with, in at least a first configuration, said memory operating as a 0 bit when the subtracted-input-paths output state of the first beam splitter has a probability amplitude of 0, or acting as a 1 bit when the subtracted-input-paths output state of the first beam splitter has a probability amplitude of 1. A twenty-second embodiment is characterizable as an additional photon processing feature of a quantum-computing photon processing system of the twentieth embodiment, in combination with one or more photonic quantum computing logic gates configured to utilize said feature as a binary photon state memory with, in at least a second configuration, said memory operating as a 0 bit when the added-input-paths output state of the first beam splitter has a probability amplitude of 0, or acting as a 1 bit when the added-input-paths output state of the first beam splitter has a probability amplitude of 1.

A twenty third embodiment is characterizable as a method of photonic quantum computing, comprising the steps of: receiving and processing control and signal bit photon states with one or more photonic quantum computing logic gates, wherein a first of said logic gates is comprised of, a first quantum differentiator that separates first and second orthogonal states of a signal bit photon for processing individually by first and second quantum modifiers, respectively; said modifiers' processing involving self-interference sections operating in either a first or a second mode which output, respectively, either the same or the alternative of the input state; first and second paths for first and second states, respectively, of a control bit photon arranged, when occupied, to switch the first and second modifiers, respectively, between their first and second modes; and a quantum integrator that assembles the first and second modifiers' outputs into a unified output; discriminating one or more of the unified output's processed signal bit photon states; configuring first and second anti-symmetrical beam splitters in a looping series of beam splitters connected by bridging states, said configuring involving, a first bridging state between a first beam splitter positive-side first output and a second beam splitter positive-side third input, a second bridging state between a first beam splitter negative-side second output and a second beam splitter negative-side fourth input, a third bridging state between a positive-side third output of the second beam splitter and a first beam splitter positive-side first input, and a fourth bridging state between a second beam splitter negative-side fourth output and a first beam splitter negative-side second input, interrelating, with one or more linking phase modifiers, one or more of the discriminated states with one or more of the first through fourth bridging states; and selectively phase modifying one or more of the bridging states by said interrelating to one or more of the discriminated states, and/or selectively phase modifying one or more of the discriminated states by said interrelating to one or more of the bridging states.

A twenty fourth embodiment is characterizable as a quantum memory for a photonic quantum computing system comprising: first and second anti-symmetrical beam splitters, each having two inputs and two outputs; a first bridging state between first beam splitter positive-side first output and second beam splitter positive-side third input; a second bridging state between first beam splitter negative-side second output and second beam splitter negative-side fourth input; a third bridging state between second beam splitter positive-side third output and first beam splitter positive-side first input; a fourth bridging state between second beam splitter negative-side fourth output and first beam splitter negative-side second input; one or more photons circulating from the first beam splitter outputs in a superposition of the first and second bridging states to the second beam splitter inputs, and from one of the second beam splitter outputs, not-superpositioned, in either the third or the fourth bridging states; said photons circulation occurring in either a first or a second mode, wherein the first mode occupies the first and second bridging states in an in-phase superposition, and occupies the third, but not the fourth, bridging state, while the second mode occupies the first and second bridging states in a a out-of-phase superposition, and occupies the fourth, but not the third, bridging state.

A twenty fifth embodiment is characterizable as an additional quantum memory for a photonic quantum computing system of the twenty fourth embodiment, further comprising one or more phase modifiers each configured to effect a r phase shift on photons traversing a bridging state interrelated with that phase modifier, wherein said a phase shift effect on either of the first or second bridging states, when in the first mode, switches the memory system to the second mode, and said a phase shift effect on either of the first or second bridging states, when in the second mode, switches the memory system to the first mode. A twenty sixth embodiment is characterizable as an additional quantum memory for a photonic quantum computing system of the twenty fourth embodiment, further comprising one or more optical various components interrelated with the third and/or fourth bridging states that variously “read” the memory mode, energize the traversing state, filter the traversing state, amplitude or frequency modulate the traversing state, and/or other effects upon circulating photons, and do not decohere or alter the first and second bridging states' superposition. A twenty seventh embodiment is characterizable as an additional quantum memory for a photonic quantum computing system of the twenty fourth embodiment, further comprising one or more network interrelations with one or more photonic quantum computing logic gates, potentially mediated and/or embodied by one or more photonic quantum switches, said network interrelations configured to route a first output state of a first logic gate to an interrelation with a first phase modifier that also interrelates with the first bridging state and effects a r phase shift on its occupying photons and switches modes of the memory system, when a first logic gate's first output state is occupied. A twenty eighth embodiment is characterizable as an additional quantum memory for a photonic quantum computing system of the twenty fourth embodiment, further comprising one or more network interrelations, potentially mediated and/or embodied by one or more photonic quantum switches including polarizing switches that differentially operate for differing photon polarization states, said network interrelations configured to route a discerned entangled state, identified by interleaved first and second superpositionings, to an interrelation with a selected phase modifier that also interrelates with a selected memory system's first bridging state and effects a π phase shift on its occupying photons, switching modes of the memory system, when an entangled state is discerned.

A twenty ninth embodiment is characterizable as a photonic memory and photon processing modifiable quantum logic gate aspects of a quantum-computing photon processing system, comprising: one or more quantum logic gate aspects, wherein said gate aspects involve a receiver/communicator of signal photons sent to a first superpositioner that arranges a first superposition of distinguishable signal photon first and second states, wherein said distinguishableness enables differentiable influences upon the first and second states; one or more conditioners to differentiably influence the first and second states to engender conditioned states that exhibit influenced degrees of constructive or destructive self-interference; a first interference actuator that institutes self-interference of the signal photon conditioned states; a first differentiator between first and second orthogonal basis states, said differentiator receives one or more signal photon post-self-interference states and inputs the first and second orthogonally differentiated post-self-interference states for individual processing by first and second quantum modifiers, respectively; said modifiers' processing involving a self-interference section operating in either a first or a second mode which output, respectively, either the same or the alternative of the input state; one or more control photon states arranged to alter the mode of self-interference undergone by one or more of the post-self-interference state outputs in at least one of the quantum modifiers to enable logic gate operations in accordance with a logical operations table of a logic gate for the control and signal photons; a quantum integrator that assembles the first and second modifiers' outputs and channels them into a single unified output; and/or one or more quantum switch aspects, wherein said switch aspects involve receiving and communicating photons to a first superpositioner; arranging a first superposition of distinguishable photon first and second states with the first superpositioner; differentiably influencing the first and second distinguishable states to engender conditioned states that will exhibit influenced degrees of constructive or destructive self-interference; instituting self-interference of the conditioned states with an interference actuator; and outputting one or more photon post-self-interference states, and/or one or more quantum memory aspects, wherein said memory aspects involve first and second anti-symmetrical beam splitters, each having two inputs and two outputs; a first bridging state between first beam splitter positive-side first output and second beam splitter positive-side third input; a second bridging state between first beam splitter negative-side second output and second beam splitter negative-side fourth input; a third bridging state between second beam splitter positive-side third output and first beam splitter positive-side first input; a fourth bridging state between second beam splitter negative-side fourth output and first beam splitter negative-side second input; one or more photons circulating from the first beam splitter outputs in a superposition of the first and second bridging states to the second beam splitter inputs, and from one of the second beam splitter outputs, not-superpositioned, in either the third or the fourth bridging states; said photons circulation occurring in either a first or a second mode, wherein the first mode occupies the first and second bridging states in an in-phase superposition, and occupies the third, but not the fourth, bridging state, while the second mode occupies the first and second bridging states in a π out-of-phase superposition, and occupies the fourth, but not the third, bridging state.

The full range of embodiments of the present invention also include permutations and combinations of the various sub-sections of the above embodiments, such as a network that interrelates three, four, or more logic gates, as well as multiple interconnections (for example, by arranging intersections with an extended Kerr media configuration for a multitude of the self-interference and/or self-interference output section paths) between various parts of one or more gates and with various parts of one or more other gates. Other objects and features will be in part apparent and in part pointed out hereinafter.

### BRIEF DESCRIPTION OF THE DRAWINGS

FIG. 1 is a schematic representation of a first logic gate of an optical information processing embodiment of the present invention.

FIG. 2 is a schematic representation of a networked pair of logic gates of an optical information processing embodiment of the present invention.

FIG. 3 is a schematic representation of a first quantum switch aspect of the present invention.

FIG. 4 is a schematic representation of a second quantum switch aspect of the present invention.

FIG. 5 is a schematic representation of a third quantum switch aspect of the present invention.

FIG. 6 is schematic representation of a fifth quantum switch aspect of the present invention.

FIG. 7 is schematic representation of a quantum filtering/discerning aspect includable in varying quantum computing optical information processing embodiments of the present invention.

FIG. 8 is schematic representation of a first quantum memory aspect of the present invention.

FIG. 9 is a schematic representation of an optical information processing system first quantum memory aspect incorporating embodiment of the present invention.

FIG. 10 is a schematic representation of differing forms of interaction between quantum switching aspects and the first quantum memory aspect of the present invention.

### DETAILED DESCRIPTION OF THE PREFERRED EMBODIMENTS

In the following description, identical numbers indicate identical elements. Where an element has been described in one Figure, and is unaltered in detail or relation in any other Figure, said element description applies to all Figures. Primarily for purposes of clarity of illustration and description, the present drawing figures and their accompanying detailed descriptions of the embodiments in the figures are shown with straight paths for the photons such as they would exhibit when passing through space, but it should be understood that this is not limiting of the embodiments of the present invention. Essentially any manner of channeling and/or directing photons can also serve in the present invention, including optical fibers, rectangular wave guides on silicon chip, and others. Additionally, the utilizations of polarizing, symmetrical, and anti-symmetrical beam splitters are also not limiting of the types and varieties of equipment that can be used in the embodiments of the present invention, since it is only the resulting effects described that are of significance, and alternative means to achieve those effects are within the scope of the present invention, since these are well known and in many cases decades old devices. As used herein, the mirrors depicted as enacting the variety of direction changing actions on the photons are assumed to be non-phase shifting, i.e. they have glass on both sides of the reflecting layer, unless otherwise specified (such as when an anti-symmetrical mirror is utilized.)

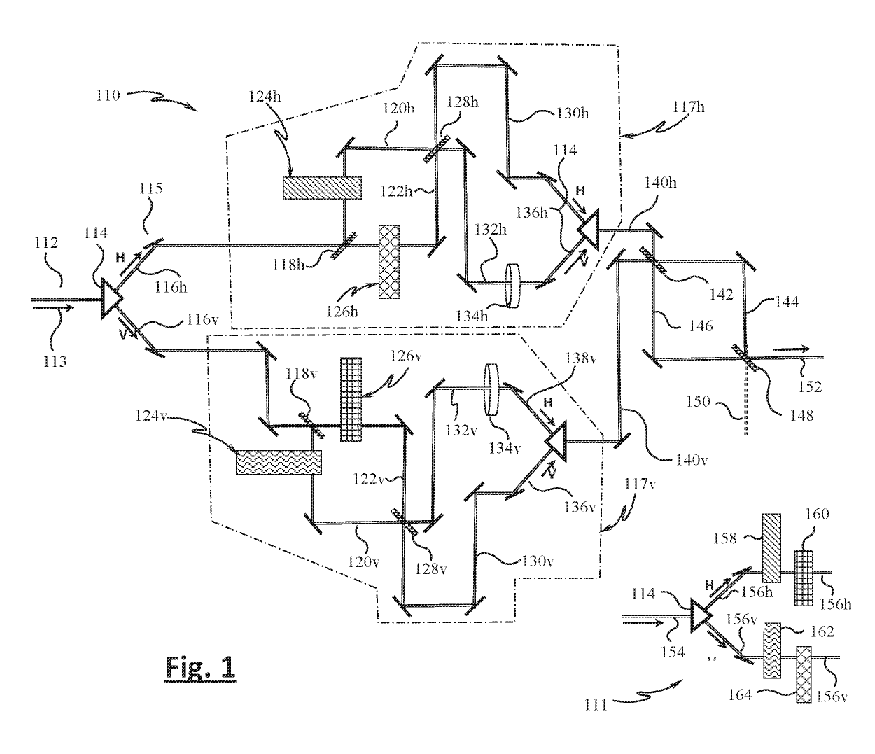

Depicted in FIG. 1 is a first logic gate embodiment that comprises a signal processor sector 110 and a control enactor sector 111 that interacts with the signal processor sector 110 to accomplish the operations of the first logic gate embodiment. A first photon in either the H or V state enters the signal processor sector 110 via the path 112 in travelling in the direction 113 to the polarizing beam splitter 114. Once passing through the polarizing beam splitter 114, the H state photons are directed onto path 116 hand the V state photons are directed onto the path 116 v. The H state photon then enters the quantum modifier 117 h and the V state photon enters the corresponding quantum modifier 117 v. The modifiers 117 h and 117 v are essentially equivalent, and are depicted as mirror images, though their functions are fully analogous and the mirror imaging does not alter their performance. Some of the effects of the two quantum modifiers are correspondingly different, such as the quantum modifier 117 h potentially changing a H state photon into a V state photon, and vice-versa for quantum modifier 117 v. Other differences will reflect the nature of the logic operation being enacted, and are primarily related to variations in which phase shifting potential interactions are actually realized in various combinations of the photon states entering the first logic gate embodiment. As stated earlier, the majority of the present description involves utilizing optical Kerr media to enact the phase shifting interactions prescribed by a given logic operation, though a wide variety of other well-known means are also within the scope of the present invention. Additionally, the details of the manner of a particular form of realization of an optical Kerr media are not the subject of the present application, sufficient manners of realization such as those mentioned and incorporated by reference do exist, and are effective. Improvements are also inevitably forthcoming and such are also utilizable in concert with the present invention. Hence, the manners of utilization of optical Kerr media in the present descriptions will be limited to statements of their specific use, with the understanding that the details are sufficiently well-known and public already.

The following description of quantum modifier 117 h (117 v) also serves to describe quantum modifier 117 v, with the substitution of the “v” suffix for the “h” suffix. Upon inputting to quantum modifier 117 h (117 v), the H-state photon encounters 50-50 symmetrical (i.e. non-phase shifting reflections) beam splitter 118 h (118 v), and it becomes the state [H: 2½ (120 h (120 v)+122 h (122 v))] which has equal probability amplitudes of traveling down both paths 120 h (120 v) and 122 h (122 v). A first optical Kerr media 124 h (124 v) is traversed by path 129 h (129 v), and a second optical Kerr media 126 h (126 v) is traversed by path 122 h (122 v), prior to the two paths crossing at anti-symmetrical beam splitter 128 h (128 v). The anti-symmetrical 50-50 beam splitter 128 h (128 v) is arranged so that the side which directs its reflections from path 120 h (120 v) to path 130 h (130 v) is not phase shifting while the side which directs its reflections from path 122 h (122 v) to path 132 h (132 v) does induce a π phase shift in the state that takes path 132 h (132 v). Hence, if there are no phase shifts enacted by either of the optical Kerr medias 124 h (124 v) and 126 h (126 v), the photon state will take path 130 h (130 v) when exiting the anti-symmetrical beam splitter 128 h (128 v), while if either of the optical Kerr medias 124 h (124 v) and 126 h (126 v) do enact a phase shifts, the photon state exiting the anti-symmetrical beam splitter 128 h (128 v) will take path 132 h (132 v). When following path 132 h (132 v) the photon state will pass through half-wave plate 134 h (134 v) and be switched to a V photon now travelling along path 136 h (136 v). The two paths 130 h (130 v) and 136 h (136 v) are recombined by a reversed direction polarizing beam splitter 114 and output from quantum modifier 117 h (117 v) along path 140 h (140 v). The paths 140 h (140 v) and 140 v are then crossed at symmetrical 50-50 beam splitter 142, so that the exiting paths 144 and 146 are populated by identical states. The states following paths 144 and 146 are then re-crossed again at anti-symmetrical 50-50 beam splitter 148, which ensures that only output path 152 is populated, since path 150 will has a 0 probability amplitude of being populated.

A second, so-called control photon, designated as the b photon in the above detailed truth tables (and hence the photon traversing the signal processor sector 110 would be the a photon) inputs to the control enactor sector 111 along path 154 and traverses another polarizing beam splitter 114. As described previously, the polarizing beam splitter 114 sends H state photons along path 156 h and V state photons along path 156 v. The photon state traversing path 156 h will also traverse potential optical Kerr medias 158 and/or 160 in potential concurrence with a photon state traversing optical Kerr medias 124 h and 126 v, respectively. The photon state traversing path 156 v will also traverse potential optical Kerr medias 162 and/or 164 in potential concurrence with a photon state traversing optical Kerr medias 120 v and 126 v, respectively. When either concurrency is established, the photon state traversing the portion of the signal processor sector 110 that shares that concurrency will undergo a π phase shift, and hence will exit from the other path, either path 132 h or path 132 v, than if there is no phase shift from a concurrency. The paths 132 v and 132 h traverse the half wave plates 134 h and 134 v, respectively, and hence the photon state on that path has its direction of polarization switched (either from H to V, or from V to H,) and hence its binary value is switched, since the H photon state is taken as equivalent to a one in the truth table and a V photon state is taken as equivalent to the 0 in the truth table. The connections between the various optical Kerr media and the establishing of the particulars of the concurrencies are not inconsiderable achievements, but they execution and the issues involved have been well known for decades or longer, and are already well explained in many published texts including those incorporated by reference herein as well as the parent applications to the present application. The manners of utilizing these concurrencies to establish logical operations and logic gate varieties have already been described in the summary of the invention and will be explicated further in the claims.

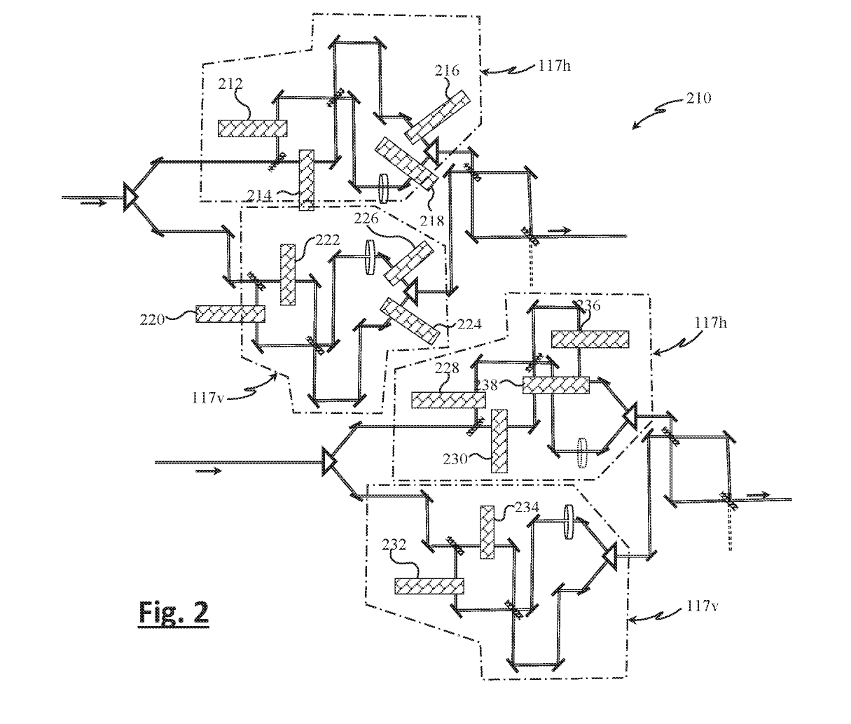

Depicted in FIG. 2 is a logic gate network embodiment 210 that comprises a pair of interrelated signal processor sectors 110 acting, depending on the various configurations arranged and the states being input, as control enactor sectors 111 for each other, as well as for other gates, again depending on the various configurations arranged and the states being input. In all of the embodiments depicted in detail or merely referred to (such as a description of a string of a large multitude of networked logic gates, while only showing two because the ability to replicate more copies is obvious from the two illustrated,) though not necessarily fully illustrated, the arrangements of the paths, their lengths and timing, and their manners of providing opportunities for interconnections with various optical Kerr media as well as other input and output paths are fully flexible, with only the necessary well-known and well-handled (as shown in the parent applications as well as the incorporated references.) approaches to managing constraints of coherence maintenance, path length equivalence, etc. And as mentioned previously, any of a variety of forms of optical path technologies are usable as well including optical fibers, wave guides on silicon chip, and others.

In FIG. 2, a plurality of arrangements of potential optical Kerr media interactions are provided, by the arrangements of the optical Kerr medias 212, 214, 216, 218, 220, 222, 224, 226, 228, 230, 232, 234, 236, and 238. The specific number, placements, concurrencies, and further external interactions of any and all of these optical Kerr medias 212-238 are all adaptable, including increases, decreases, and sequencing. Phase shifting interactions such as in the description of FIG. 1 are available, of course, as well as those in which multiple optical Kerr medias 212-238 are disposed and concurrently occupied within a single self-interference section such as that of the upper quantum modifier 117 h. In such a way, a self-interference section could be influenced to shift the phase, and hence switch the output state, by one of the optical Kerr media and then also switched by another different optical Kerr media so that the result would be that the presence of both would cancel each other out. A third optical Kerr media (not shown) could also be introduced so that the presence of 1 or 3 of the concurrencies would shift the phase and switch the state, while the presence of two or none would not.

Furthermore, the result of a phase shift in a first self-interference section of a first logic gate could alter the phase shift of a first self-interference section in a second logic gate which would then in turn, as a result of that first phase shift, output a different state which could then be arranged to alter the phase shift of a second self-interference section of the first logic gate. In other words, optical Kerr medias 212 and 236 could be arranged to enact a concurrency for a given pair of photon states traversing each of the pair of logic gates in the logic gate network embodiment 210 so that the phase of the state traversing optical Kerr media 212 is shifted, thereby causing that state to output on the path that traverses optical Kerr media 216. This output state traversing optical Kerr media 216 can also be arranged, to be concurrent with a state following the path traversing optical Kerr media 234, which would then enact a phase shift for the state traversing that self-interference section. It is readily apparent that the number, and complexity of these interactions and how they can be multiplied is in principle unlimited, though of course practical considerations are likely to constrain realizations at least somewhat, and all of the potential range of these networked configurations fall within the scope of the present invention.

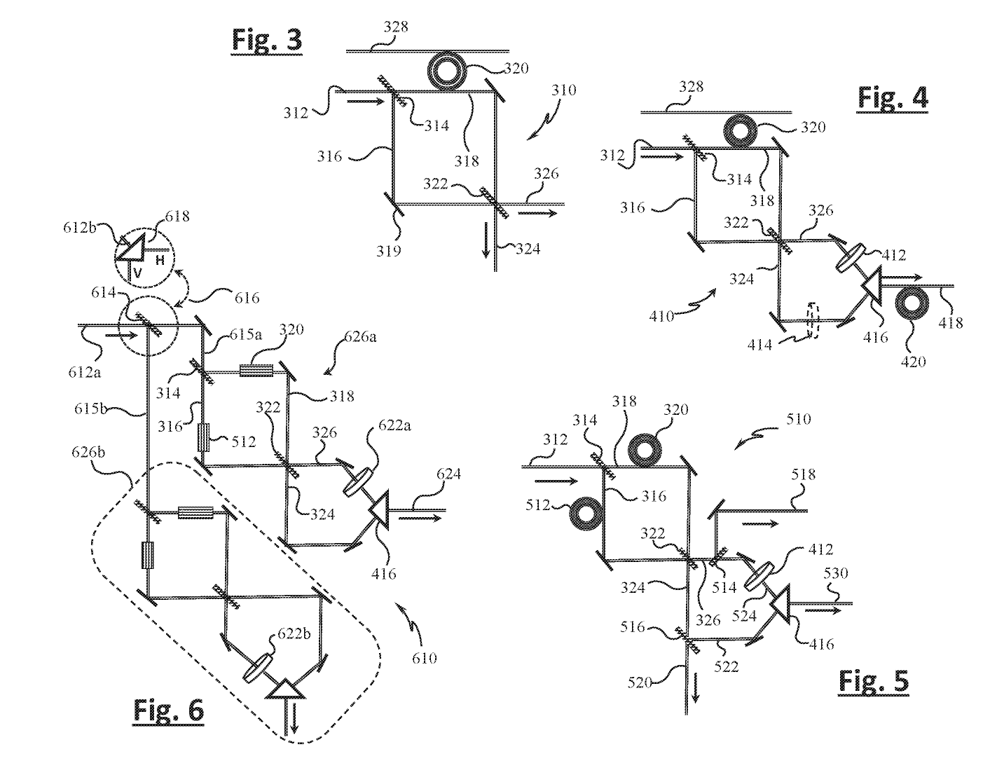

Depicted in FIG. 3 is a first quantum switch aspect 310 suited for inclusion in various quantum computing processing system embodiments according to the present invention. A signal photon is received along path 312 leading to a symmetrical first 50-50 beam splitter 314 that directs the photon with equal probabilities onto paths 316 and 318. (It should be noted that while the beam splitters described herein are generally described as 50-50 probabilities of either output path being taken, they can also have unbalanced probabilities wherein one path is more likely than the other, with the attendant more complicated state evolutions. While there are some advantageous of non-50-50 beam splitters, their operation in principle is not substantially different and is well known. Both the 50-50 and the non-50-50 beam splitters, when incorporated in embodiments of the present invention, fall within the scope of the present invention.) The paths 316 and 318 are recombined at an anti-symmetric second 50-50 beam splitter 322 that is arranged so that its additive amplitude output side directs photons to output path 324 and its subtractive amplitude side directs photons to output path 326. A Kerr media micro-ring resonator 320 links the path 318 and a path 328 occupied by a control photon, when present. The resonance with the signal photon on the path 318 is arranged to cause the phase of the signal photon to be shifted by a, when the control photon is present. Hence, when the control photon is not present, the quantum switch aspect 310 operates to direct a photon from path 312 to the additive output path 324; and when the control photon is present the quantum switch aspect 310 directs the signal photon to the subtractive output path 326.

Depicted in FIG. 4 is a polarizing second quantum switch aspect 410 that incorporates the first quantum switch aspect 310 and is also suited for inclusion in various quantum computing processing system embodiments according to the present invention. The inclusion of the ¼ wave plate 412 (and potentially also the ¼ wave plate 414) alters the polarization of a photon traversing either path 324 or 326 (e.g. from and H/V linear basis to an L/R circular polarization basis, or vice-versa). The reverse oriented polarizing beam splitter 416 recombines the polarized photon paths onto an output path 418 which can be directed to immediately resonate with an optional micro-ring resonator 420 if needed (additional relationships between the resonator 429 and additional quantum computing aspects according to the present invention of almost any permutation are readily arrangeable as is well known but not shown in FIG. 5 and also fall within the scope of the present invention).

Depicted in FIG. 5 is a branching-post-quantum-processing partially polarizing third quantum switch aspect 510 that incorporates the second quantum switch aspect 410 and is also suited for inclusion in various quantum computing processing system embodiments according to the present invention. The third quantum switch aspect 510 modifies the fourth quantum switch aspect 410 by the addition of an (optional) second resonator 512 and 50-50 beam splitters 514 and 516. The beam splitter 514 directs photons on the path 326 to output paths 518 and 524 which also traverses ¼ wave plate 412. The beam splitter 516 directs photons on the path 324 to output paths 520 and 522. The path 522 recombines with the path 524 at reversed polarizing beam splitter 416 which has a single active output path 530 that can be populated by photon states with differing polarization directions.

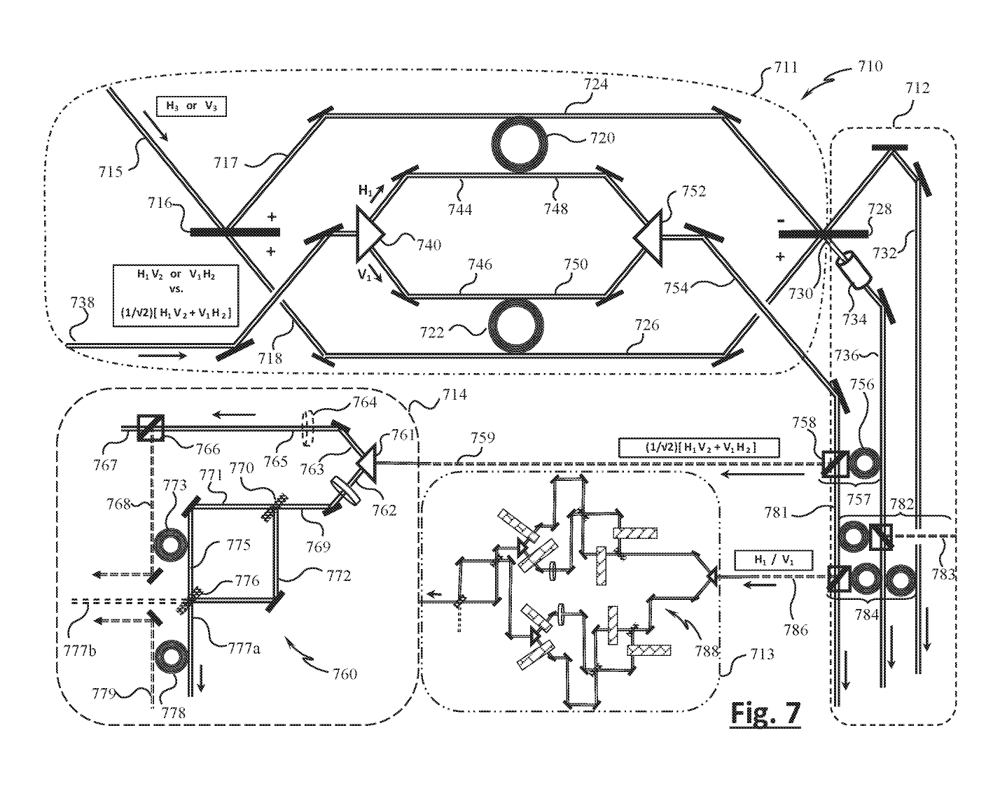

Depicted in FIG. 6 is a preliminarily branching partially polarizing fourth quantum switch aspect 610 that incorporates the first quantum switch aspect 310 and is also suited for inclusion in various quantum computing processing system embodiments according to the present invention. An entry path 612a leads to a 50-50 non-polarizing beam splitter 614 (or as an alternative 616, a path 612b that receives polarized photons leads to a 50-50 polarizing beam splitter 618.) Whether the path 612a or 612b, the following components operate essentially similarly, with the significance of the fourth quantum switch aspect 610 lying at least in part with the capacity to simultaneously produce varying polarization effects, which can also then effect varying switching effects, among other effects. A path 615b leads to a separate branch 626b, and a path 615a leads to the branch 626a which collectively functions as an analog to the branch 626b. Both of the branches 626 are similar to the second quantum switch aspect 410, with the exception of the (optional) addition of the resonator 512. Wave plates 622a and 622b provide opportunities for substantial variations, including options of neither being active, either being active, form (e.g. ¼ wave plate or ½ wave plate or . . . ) of either, differences in form when both are active, and on.

Depicted in FIG. 7 is a quantum discerning aspect 710 and its relations to a post-discerning filtering aspect 712, an optional post discerning/filtering processing logic gate 713, and/or a post discerning/filtering quantum switching aspect 714 all potentially constituents, in varying permutations, of the quantum computing system embodiments of the present invention. The quantum discerning aspect 710 receives indicator photons on path 715 which traverse 50-50 beam splitter 716, which has essentially identical upper exit path 717 and lower exit path 718. The paths 717 and 718 traverse resonators 720 and 722, respectively, whence they are paths 724 and 726, respectively, which then cross at anti-symmetric, 50-50 beam splitter 728, disposed with its subtractive side facing up as shown in FIG. 7. Beam splitter 730 has exit paths 730 and 732 that exit the quantum discerning aspect 711 and enter the quantum filtering aspect 712. A single detector 734 is sufficient to determine the exit path (730 or 732) from the quantum discerning aspect 711 that is occupied. The detector 734 can be non-operative or absent, or at least non-demolishing of the photon on the path 730 in which case that photon continues on path 736. Unfiltered signal photons are received on the path 738 that enters polarizing beam splitter 740 whose upper exit path 744 is arranged to also resonate with resonator 720 and thereafter is path 748. The polarizing beam splitter 740 lower exit path 746 is arranged to also resonate with resonator 722 and thereafter is path 750 which is recombined with the path 748 at reversed polarizing beam splitter 752. Paths 724 and 726 (as well as paths 748 and 750) along with the preceding photon paths and traversed constituents of quantum discerning aspect 711 are arranged so that the photons arrive at each of the beam splitters 728 (and 752) in coherence from both entry paths to that beam splitter.

Among the primary functions of the quantum discerning aspect 711 is to enable discernment between a photon state that is in a first superposition of states and a photon state that is a result of the demolishing of the first superposition of states. Often this is characterizable in terms of well known basis states such as the horizontal (H) and vertical (V) linear polarization bases. These are an effective proxy for other bases states, and as is well known to those of skill in the art, can be rotated into other bases states with unitary rotations. Also of particular note in this case is the use of the quantum discerning aspect with an entangled superposition of states, in particular when the signal photons, designated by subscript “1”, share an entangled superposition of states with distant photons designated by a subscript “2”: ω₁^{E}=(1√2)[H₁V₂+V₂H₂]. When this entangled superposition of states is demolished by observing the polarization direction of either photons 1 or photons 2 the resulting photon states are statistically most likely to be 50-50 a mix of: H₁V₂ or V₁H₂ states, with the likelihood rising as the number of observed states rises. Heretofore, hence prior to the quantum discerning aspect 711, it has been the consensus among physicists that this could not be done. The quantum discerning aspect 711 does accomplish this though, by non-demolishingly phase shifting the indicator photons with the resonance between photons on the paths 717 and 744 as well as the paths 719 and 746, via the Kerr media resonators 720 and 722, respectively. When the signal photons enter the quantum discerning aspect 711 on the path 738 in the entangled superposition of states Ψ₁^{E}, it occupies both of the paths 744 and 746 with equal probability, and hence instigates equal phase shifts. The indicator photon enters the quantum discerning aspect 711 on the path 715 in a basis state for simplicity, many other states are fine as well. The indicator photons occupy the paths 717 and 718 with equal probability, so that the difference in their phases on the paths 724 and 726, post-resonance, is due to the phase shifts from the resonators 720 and 722, respectively, and that phase shift is due to the occupancy probability of the paths 744 and 746, respectively. Hence, when the occupancy probability of the paths 744 and 746 are equal, the phase shifts of the indicator photons are equal, so that only the additive side exit path 730 is occupied. Conversely, when the occupancy probability of the paths 744 and 746 is unequal, and in the case of post-demolished Ψ₁^{E} photon states only one of the paths 744 and 746 will be occupied and the other will be unoccupied with probability 1, the phase shifts of the indicator photons are maximally unequal (0 vs. π Radians), so that only the subtractive side exit path 732 is occupied. Thus, the occupied exit path (730 or 732) indicates whether or not the signal photon states (entered the quantum discerning aspect 711 entangled and) are still in the entangled state Ψ₁^{E}, or (entered the quantum discerning aspect 711 de-entangled and were and) are the combination of the post-demolishing states (H₁V₂ or V₁H₂).

Of particular note is the effect on the signal photons caused by their phase shifting interactions with the detector photon states. When the detector photons are post-demolishing and are de-entangled, they are phase shifted, but since they are single photons there is no physical significance. When the signal photons are still in the entangled state Ψ₁^{E} each portion of each photon receives the same phase shift, and hence they remain in coherence, and following their recombination in reversed polarizing beam splitter 752, there is no other remaining physical significance other than the effect on the indicator photon states. Though the indicator photons do determine that the signal photons are still entangled, because there is no capacity to discriminate between the paths that the signal photons take when its path is divided according to polarization, hence the entanglement is preserved. Among the techniques that this enables are entanglement-based encryption methods, as well as selective entanglement-demolishing based communication protocols, both of which also involve another actor interacting with the distant photon 2 states Ψ₂^{E}=(1/√2)[H₁V₂+V₁H₂].

The post-discerning filtering aspect 712 provides means of arranging distinctive routes for the signal photons post-discerning, based on the discerning based paths taken by the indicator photon states. When the indicator photons exit the quantum discerning aspect 711 on path 730, in addition to being able to be registered by the detector 734, they can also (or alternatively) continue on path 736. The indicator photons being on the path 730 means that the signal photons were and are entangled. As the signal photons exit the reversed polarizing beam splitter 752 on path 754 they and the indicator photons on the path 736 can be arranged to simultaneously resonate with a resonator 756. A dual path enacted combination switch 757 combines the resonator 756 with a resonance enacted phase shift based switch 758 constructed, for example, like the quantum switch aspect 310. The combination switch 757 allows the entanglement based filtering of entangled photons from path 754 to path 759.

Those photons that are routed onto the path 759 then enter the post discerning/filtering quantum switching aspect 714 upon which their path enters a (often polarizing) beam splitter 761 that has exit paths 762 and 763. Photon states on the path 763 may have their polarization direction shifted by a potentially included wave plate 764, and their path 765 may then include another partial beam splitter, with exit paths 767 and 768. The path 762 also can be polarization shifted by a wave plate and then continue on path 769 until entering a 50-50 beam splitter 770 which has exit paths 771 and 772. A resonator 773 can be disposed so that a photon state on the path 768 (and any other photon path, not shown in FIG. 7, that is also arranged to resonate with the resonator 773,) so that the photon state on path 775 may be phase shifted. An antisymmetric 50-50 beam splitter 776, depending on its orientation and the appropriate arrangement of the arriving photon states, will direct exiting photon states onto the either path 777a or 777b in accordance with the enacted (or not) phase shift between the paths 771 and 775. An additional resonator 778 and additional signal photon on the path 779 can be disposed so that it is phase shifted (e.g. useful for processing if the path 779 is part of a larger apparatus,) due to the photon state on the path 777a.

Another of the combination switches 757 can be disposed along a path 781 in the arrangement 782, and when the signal photon occupies the path 730 and is not diverted onto path 759, it can then be a control photon state that can selectively switch the photon state on path 736 to an exiting path 783 for additional utilization. In addition, a dual resonating switch 784 can be disposed along the path 781 as well, the switch 784 being able to enact phase shifts form either or both of the paths 732 and 736, to then selectively, or not, send the photon state on the path 781 to the path 786 enters the post discerning/filtering processing logic gate 713, which can include an unlimited amount of further quantum computing aspects including, for example, a processing gate 788.

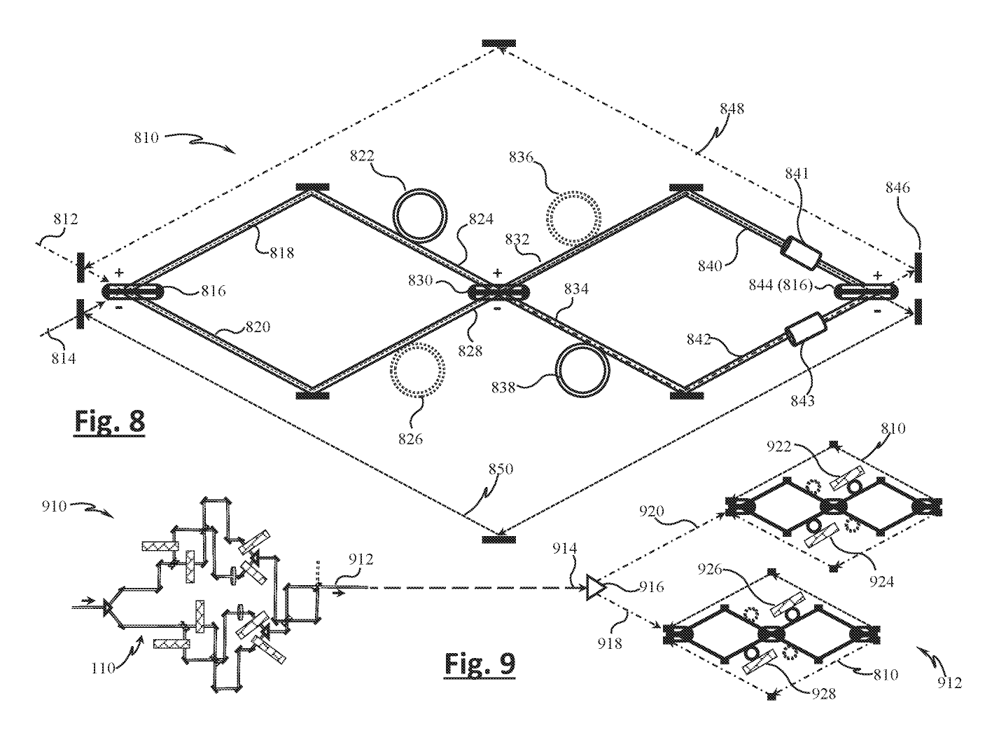

FIG. 8 depicts a first quantum memory aspect 810 that is at essence, relatively symmetric in construction but can be reconfigured asymmetrically as well, though its functions become more complicated to illustrate, so that for clarity of communication only, the present application will describe symmetric memory configurations, with the caveat noted that in principle the scope of the present invention also encompasses asymmetrical memory configurations as well. Photon states can be received at either path 812 or 814, though the difference in path will have effects on the manner of functioning of the first quantum memory aspect 810. A photon state entering on the path 812 encounters the anti-symmetric 50-50 beam splitter on its positive reflecting side so that its reflected portion on path 818 and its transmitted portion on path 820 have coherent phases and if unaltered will interfere constructively at a second beam anti-symmetric 50-50 splitter 830. When unaltered, the photon state on the path 818 and a path 814 are the same, as are the photon states on the path 820 and a path 828. This unaltered initial photon state exits the beam splitter 830 only on the additive side exit path 832, which is directable to a photonic apparatus 841 that can be a detector, filter, booster or other well-known photonic equipment option, including those that are non-demolishing, photon replacing, or otherwise qualifying as a quantum non-demolition measurement or interaction. After the passing of the optical apparatus 841 an unaltered photon state enters the additive side of a antisymmetric 50-50 beam splitter 844 that can also be (in fact or in effect after intermediate translation,) the beam splitter 816 when the first quantum memory aspect 810 is arranged appropriately (either by recirculating paths and reflectors 846, 848, and 850; or by spatial rearrangements in three dimensions or equivalent configuring.) If so arranged so that the beam splitters 816 and 844, for example, are identical then the unaltered photon state will continue to recirculate, if energy losses and noise are not considered. If the photon state enters on the path 814, it then progresses along the paths 818 and 820 out of phase by π radians, cross at beam splitter 830, and exit only on the subtractive side exit path 834, which can pass another general optical apparatus 843, and then can recirculate similarly to the unaltered path 812 entering photon, except with either opposite phase differences or the opposite path.

Arranged and receiving photons thusly, the first quantum memory aspect 810 has a first superimposed states (i.e. mixed states) sector between the exit paths from the beam splitter 816 and the entry paths of the beam splitter 830 wherein the circulating photon states partially occupy both of the paths 818 and 820; and a second pure states (i.e. not mixed states) sector between the exit paths from the beam splitter 830 and the entry paths of the beam splitter 816 wherein the circulating photon states fully occupy only one of the paths 840 and 842. As shown in FIG. 8, resonator 822 is disposed along the path 818, so that the photon state on the path 824 can be phase shifted as well as being able to phase shift any photon state that occupies a path (not shown) that can resonate with the resonator 822. The phase shifting outward effect can function as a “memory read” which can be selectively made to be altering, unaltering, superposition of states demolishing, and/or superposition of states non-demolishing of the circulating photon states. Analogous operations, with the appropriate alterations, apply to the optional resonator 826. The phase shifting inward effect can function as a “memory store” or other memory operation which can be selectively made to be altering, unaltering, superposition of states demolishing, and/or superposition of states non-demolishing of the circulating photon states. Similar operations, this time on the unmixed phase of the circulating photon states, are available both inward and outward via a resonator 838 and optional resonator 836 and additional (not shown) photon state paths that can resonate with them.

A representative quantum computing information processing system 910 is then seen to include a quantum computing logic gate 110, whose exiting photon states on a path 912 are directed to an entry path 914 to a polarizing (for example, or other discriminating or a non-discriminating) beam splitter 916. The beam splitter 916 directs the photon states to either or both of paths 918 and 920 that enter a pair of the quantum memory aspects 810, which are shown as networked by the potential shared resonance couplings 922, 924, 926, and 928 so that the memory configurations can be interrelated to increase the degrees of freedom available to function as memory.

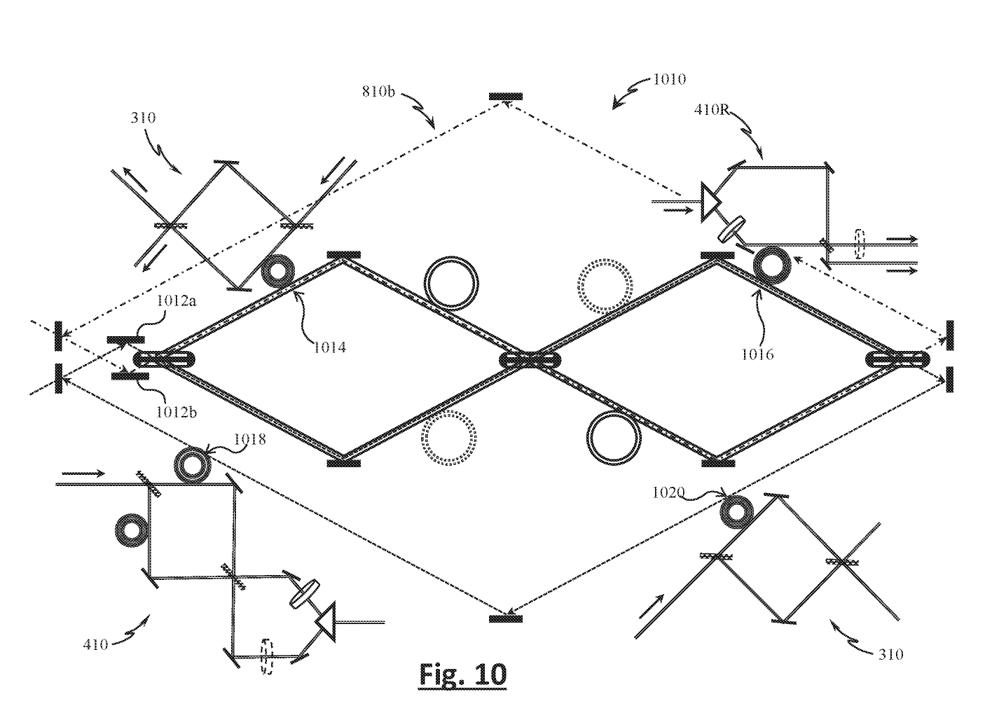

FIG. 10 depicts a representative sampling 1010 of additional manners and forms of utilizing a rearranged first quantum memory aspect 810b, including redistributing the return paths between the beam splitters 816 and 830 into the arrangement of paths and reflectors including new reflectors 1012a and 1012b. An appropriately arranged resonator of the first quantum switch aspect 310 is shown to be interactable with the path 1020; an appropriately arranged resonator of a reversed version of the second quantum switch aspect 410R is shown to be interactable with an unmixed sector of the first quantum memory aspect 810; another first quantum switch aspect 310 interacts with a mixed states sector; and another polarizing quantum switch aspect 410 interacts with the path 1018.

In view of the above, it will be seen that the various objects and features of the invention are achieved and other advantageous results obtained. The examples contained herein are merely illustrative and are not intended in a limiting sense.

What is claimed:

1. A photon processing aspect of a quantum-computing photon processing system, comprising:
a processing gate including a receiver/communicator of photons sent to a first superpositioner that arranges a first superposition of distinguishable photon first and second states, wherein said distinguishableness enables differentiable influences upon the first and second states;
one or more conditioners to differentiably influence the first and second states to engender conditioned states that exhibit influenced degrees of constructive or destructive self-interference, wherein said influencing comprises utilizing Kerr media micro-ring resonators to engender degrees of phase alteration of one or more of the first and second states;
an interference actuator that institutes self-interference of the conditioned states; and
one or more photon post-self-interference state outputs; and
a photonic quantum memory that circulates photons between mixed and pure state regions, each of said regions being potentially interrelated with one or more of said resonator influencers such that the quantum memory photon states and the processing gate photon states, and ultimately the processing gate output states, are mutually influencable.

2. A photon processing aspect of a quantum-computing photon processing system, according to claim 1, further comprising a quantum non-demolishing entangled-photon-state discerner that comprises:
a third photon state arranger of a symmetrical first superposition of third photon first and second states;
a fourth photon state arranger of a second superposition of horizontal polarization states forming a fourth photon first state and vertical polarization states forming a fourth photon second state;
one or more distinct Kerr media micro-ring resonator phase modifiers arranged to interrelate, separately, the third and fourth photons' first superpositioned states in a first pair, and their second superpositioned states in a distinct second pair;
said interrelating configured so that the fourth photon first and second superpositioned states separately induce individual phase alterations of the third photon first and second states, respectively, wherein the degree of each third photon phase alteration corresponds to the respective probability amplitude of the second photon's horizontal and vertical polarization states; and
an anti-symmetrical beam splitter arranged to interfere the third photon phase altered first and second states, the anti-symmetrical beam splitter having a first output path for added third photon probability amplitudes and a second output path for subtracted third photon probability amplitudes.

3. A photon processing, quantum non-demolishing, superposition-of-state gauging method, comprising the steps of:
organizing each of first and second photons into separate superpositions of first and second states, wherein the first photon's superposition's first and second states are symmetrical, and the second photon's superposition's first and second states are polarized, with the second photon first state being horizontally polarized and the second photon second state being vertically polarized;
interrelating each photon's first and second superpositioned state with the other photon's first and second superpositioned state, respectively;
traversing each of separate first and second phase modifiers with one each of the pairs of interrelated states, said phase modifiers using micro-ring resonators and Kerr media;
arranging said modifiers to engender alike phase modifications on traversing states when the traversing states are occupied alike, and
interfering first photon, now phase modified, first and second states at an anti-symmetrical beam splitter, wherein the anti-symmetrical beam splitter's first output path is occupied by added input states and its second output path is occupied by subtracted input states.

4. A photon processing, quantum non-demolishing, superposition-of-state gauging method according to claim 3, wherein a photon A initially shares an entangled state ψ_{A or B}=(1/(\sqrt{2})[H_{A}V_{B}+H_{B}V_{A}], or a functionally equivalent state, with a second photon B, and subsequently is still in the entangled state, or is in one of a pair of post-entangled states ψ_{A}=H_{A}V_{B} (or) V_{A}H_{B} when photon A is subsequently processed as the second photon in the method according to claim 11, further comprising the step of identifying which of the beam splitter first or second output paths the first photon traversed, and ascertaining that the second photon entered said processing in the entangled state when the first photon traverses the first output path, or ascertaining that the second photon entered said processing in one of the post-entangled states when the first photon traverses the second output path.

5. A photon processing feature of a quantum-computing photon processing system, comprising:
a first and second photon processing aspects, the first aspect including, a first beam splitter that arranges a first superposition of distinguishable photon first and second states, wherein said distinguishableness enables differentiable influences upon the first and second states;
one or more conditioners to differentiably influence the first and second states to engender first and second conditioned states;
a first interference actuator that institutes interference of the first and second conditioned states at a second beam splitter; and
post-first-interference photon first and second output states;
a second beam splitter that arranges a second superposition of distinguishable photon third and fourth states, wherein said distinguishableness enables differentiable influences upon the third and fourth states;
one or more conditioners to differentiably influence the third and fourth states to engender third and fourth conditioned states;
a second interference actuator that institutes interference of the third and fourth conditioned states at a third beam splitter; and
post-second-interference photon fifth and sixth output states;
wherein the first and second output states are the distinguishable photon third and fourth states.

6. A photon processing feature of a quantum-computing photon processing system according to claim 5, wherein the first and third beam splitters are the same beam splitter.

7. A photon processing feature of a quantum-computing photon processing system according to claim 5, wherein the first and third beam splitters are the same anti-symmetric beam splitter, and one or more photons is circulating about the photon processing feature from the first beam splitter through one or more of the first superpositioned states, then interfering at the second beam splitter and next traversing one or more of the second superpositioned states en route to crossing the first beam splitter, and potentially repeating; and
the circulating photons are arranged in either a first disposition,
wherein the first and second superpositioned states are in phase and have equal (√2)⁻¹ probability amplitudes of occupancy, and the third superpositioned state is occupied by the added-input-paths output state of the first beam splitter with a probability amplitude of 1,
or in a second disposition,
wherein the first and second superpositioned states are π out of phase and have equal (√2)⁻¹ probability amplitudes of occupancy, and the fourth superpositioned state is occupied by the subtracted-input-paths output state of the first beam splitter with a probability amplitude of 1.

8. A photon processing feature of a quantum-computing photon processing system according to claim 7, further comprising one or more phase modifiers for selectively effecting a phase modification on a modifier-traversing photon state, including a phase modification of magnitude π radians, wherein said traversing photon states include one or more of the first through fourth superpositioned states.

9. A photon processing feature of a quantum-computing photon processing system according to claim 8, in combination with one or more photonic quantum computing logic gates configured to utilize said feature as a binary photon state memory with, in at least a first configuration, said memory operating as a 0 bit when the subtracted-input-paths output state of the first beam splitter has a probability amplitude of 0, or acting as a 1 bit when the subtracted-input-paths output state of the first beam splitter has a probability amplitude of 1.

10. A photon processing feature of a quantum-computing photon processing system according to claim 8, in combination with one or more photonic quantum computing logic gates configured to utilize said feature as a binary photon state memory with, in at least a second configuration, said memory operating as a 0 bit when the added-input-paths output state of the first beam splitter has a probability amplitude of 0, or acting as a 1 bit when the added-input-paths output state of the first beam splitter has a probability amplitude of 1.

11. A quantum memory for a photonic quantum computing system comprising:
first and second anti-symmetrical beam splitters, each having two inputs and two outputs;
a first bridging state between first beam splitter positive-side first output and second beam splitter positive-side third input;
a second bridging state between first beam splitter negative-side second output and second beam splitter negative-side fourth input;
a third bridging state between second beam splitter positive-side third output and first beam splitter positive-side first input;
a fourth bridging state between second beam splitter negative-side fourth output and first beam splitter negative-side second input;
one or more photons circulating from the first beam splitter outputs in a superposition of the first and second bridging states to the second beam splitter inputs, and from one of the second beam splitter outputs, not-superpositioned, in either the third or the fourth bridging states;
said photons circulation occurring in either a first or a second mode, wherein
the first mode occupies the first and second bridging states in an in-phase superposition, and occupies the third, but not the fourth, bridging state, while
the second mode occupies the first and second bridging states in a π out-of-phase superposition, and occupies the fourth, but not the third, bridging state.

12. A quantum memory for a photonic quantum computing system according to claim 11, further comprising one or more phase modifiers each configured to effect a π phase shift on photons traversing a bridging state interrelated with that phase modifier, wherein
said π phase shift effect on either of the first or second bridging states, when in the first mode, switches the memory system to the second mode, and
said π phase shift effect on either of the first or second bridging states, when in the second mode, switches the memory system to the first mode.

13. A quantum memory for a photonic quantum computing system according to claim 11, further comprising one or more optical various components interrelated with the third and/or fourth bridging states that variously “read” the memory mode, energize the traversing state, filter the traversing state, amplitude or frequency modulate the traversing state, and/or other effects upon circulating photons, and do not decohere or alter the first and second bridging states' superposition.

14. A quantum memory for a photonic quantum computing system according to claim 11, further comprising one or more network interrelations with one or more photonic quantum computing logic gates, potentially mediated and/or embodied by one or more photonic quantum switches, said network interrelations configured to route a first output state of a first logic gate to an interrelation with a first phase modifier that also interrelates with the first bridging state and effects a r phase shift on its occupying photons and switches modes of the memory system, when a first logic gate's first output state is occupied.

15. A quantum memory for a photonic quantum computing system according to claim 11, further comprising one or more network interrelations, potentially mediated and/or embodied by one or more photonic quantum switches including polarizing switches that differentially operate for differing photon polarization states, said network interrelations configured to route a discerned entangled state, identified by interleaved first and second superpositionings, to an interrelation with a selected phase modifier that also interrelates with a selected memory system's first bridging state and effects a s phase shift on its occupying photons, switching modes of the memory system, when an entangled state is discerned.
